(19) United States
(12) Patent Application Publication
(10) Pub. No.: US 2018/0121045 A1
(43) Pub. Date: May 3, 2018

(54) TOGGLING APPLICATION FEATURE FLAGS BASED ON USER SENTIMENT

(71) Applicant: HEWLETT PACKARD ENTERPRISE DEVELOPMENT LP, Houston, TX (US)

(72) Inventors: Avigad Mizrahi, Yehud (IL); Elad Levi, Yehud (IL); Ran Bar Zik, Yehud (IL)

(21) Appl. No.: 15/340,102

(22) Filed: Nov. 1, 2016

(51) Int. Cl. G06F 3/0484

(52) U.S. Cl. CPC G06F 3/0484; G06F 2203/011

(57) ABSTRACT

In some examples, a user sentiment of an end user that is interacting with an application to be executed on a client computing device may be inferred based on biometric data of the end user. A feature flag of the application may be toggled based on the inferred user sentiment.

### BACKGROUND

A feature flag, also known as a feature toggle, is a coding technique whereby features of an application (i.e. software application) may be toggled (e.g. enable, disabled, hidden, etc.).

### BRIEF DESCRIPTION

Some examples are described with respect to the following figures:

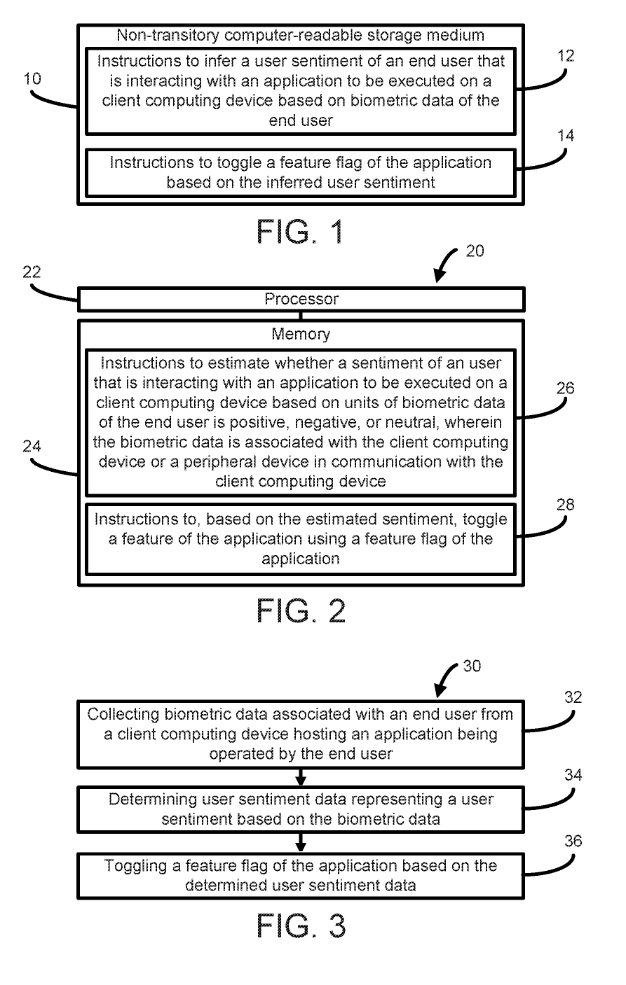

FIG. 1 is a block diagram illustrating a non-transitory computer readable storage medium according to some examples.

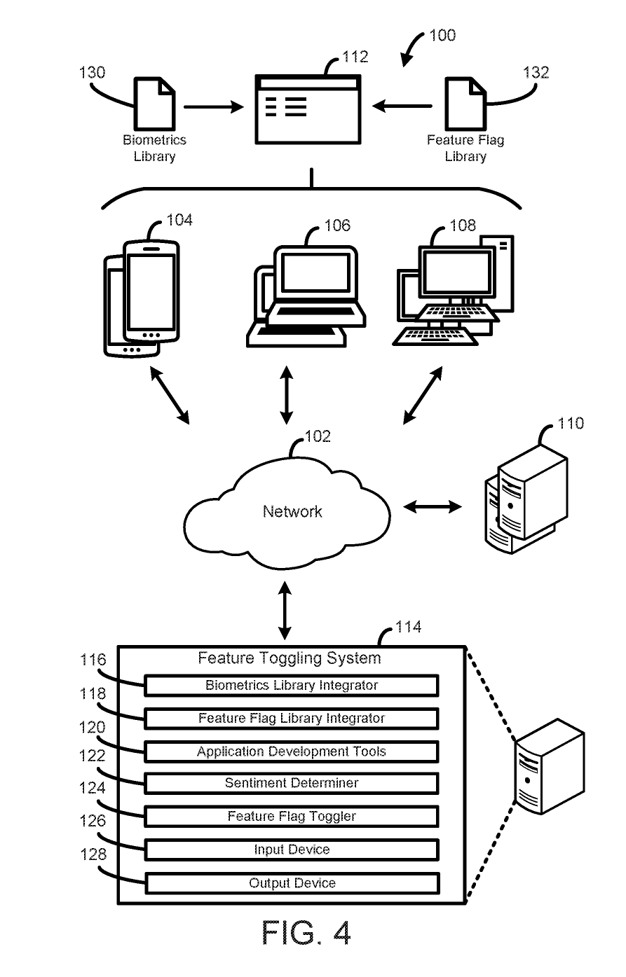

FIGS. 2 and 4 are block diagrams illustrating systems according to some examples.

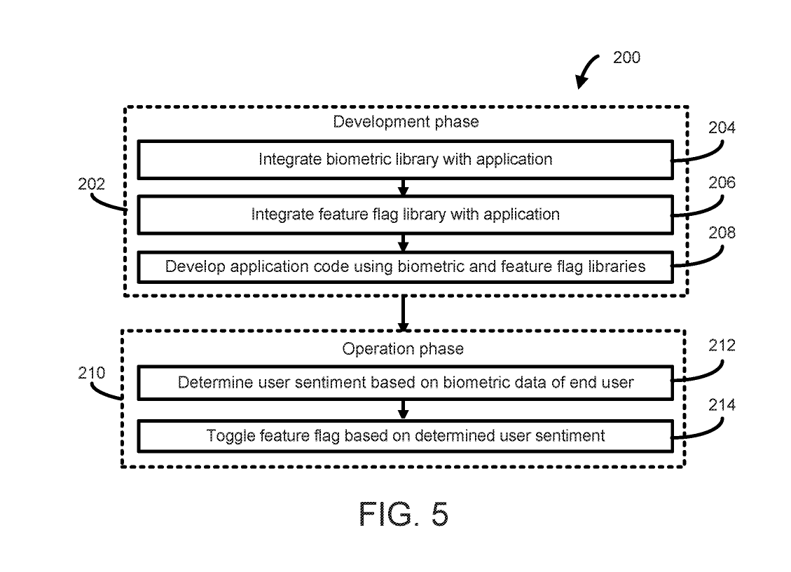

FIGS. 3 and 5 flow diagrams illustrating methods according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Continuous delivery may involve building, testing, and releasing applications reliably and frequently in short cycles. This may involve incremental rather than major updates in each released version of an application, and may reduce risks, costs, and time in delivering these incremental updates. Continuous delivery may also involve repeatable processes for delivery of successive versions of an application.

In continuous delivery, new features may be delivered quickly as they are developed. New features may include application functionalities, bug fixes, new messages to users, etc. In some examples, these features may be selectively deployed to users during continuous delivery, such that some users receive some new features, other users receive other new features, while yet others do not receive any of the new features. Therefore, feature flags may be used to test an application with these different sets of users by selectively deploying features of the application. This may enhance operation of continuous delivery.

Feature flags may be implemented in a variety of ways. In some examples, a feature flag may be implemented as “if-else” or equivalent statements in code of an application according to parameters such as logged user role, geographic location of user, randomly selected users, etc. Thus, features may be toggled, e.g. enabled or disabled, according to these parameters. However, in some examples, the toggling of feature flags may not account for a sufficient amount of information about users, and therefore features may not be selectively deployed effectively in a way that optimizes testing.

Accordingly, the present disclosures provides examples in which the toggling of feature flags is based on user sentiment inferred from biometric data of the user while the end user uses the application. This technique allows for superior determinations of which users should receive which features at which times, and therefore allows for superior testing, deployment, and user experience of applications. “Sentiment” is understood herein as an attitude of an end user, e.g. towards an application being used by the end user. The attitude may be an affective state (e.g. feeling or emotion) of the end user.

FIG. 1 is a block diagram illustrating a non-transitory computer readable storage medium 10 according to some examples. The non-transitory computer readable storage medium 10 may include instructions 12 executable by a processor to infer a user sentiment of an end user that is interacting with an application to be executed on a client computing device based on biometric data of the end user. The non-transitory computer readable storage medium 10 may include instructions 14 executable by a processor to toggle a feature flag of the application based on the inferred user sentiment.

FIG. 2 is a block diagram illustrating a system 20 according to some examples. The system 20 may include a processor 22 and a memory 24. The memory 24 may include instructions 26 executable by the processor 22 to estimate whether a sentiment of an user that is interacting with an application to be executed on a client computing device based on units of biometric data of the end user is positive, negative, or neutral, wherein the biometric data is associated with the client computing device or a peripheral device in communication with the client computing device. The memory 24 may include instructions 28 executable by the processor 22 to, based on the estimated sentiment, toggle a feature of the application using a feature flag of the application.

FIG. 3 is a flow diagram illustrating a method 30 according to some examples. The following may be performed by a processor. The method 30 may include: at 32, collecting biometric data associated with an end user from a client computing device hosting an application being operated by the end user; at 34, determining user sentiment data representing a user sentiment based on the biometric data; at 36, toggling a feature flag of the application based on the determined user sentiment data.

FIG. 4 is a block diagram illustrating a system 100 according to some examples. The system 100 includes a network 102, such as a local area network (LAN), wide area network (WAN), the Internet, or any other network. The system 100 may include multiple client computing devices in communication with the network 102, such as mobile computing devices 104 (e.g. smart phones and tablets), laptop computers 106, and desktop computers 108. Other types of client computing devices may also be in communication with the network 102. The system 100 may also include web servers 110 in communication with the network 102.

The system 100 may include a feature toggling system 114 in communication with the network 102. The feature toggling system 114 may include a biometrics library integrator 116, feature flag library integrator 118, application development tools 120, sentiment determiner 122, and feature flag toggler 124. In some examples, the feature toggling system 114 may comprise a server computing device, or any other type of computing device. In some examples, the feature toggling system 114 may be part of an administrator computing device to be operated by a user such as an IT professional. The feature toggling system 114 may support direct user interaction. For example, the feature toggling system 114 may include user input device 126, such as a keyboard, touchpad, buttons, keypad, dials, mouse, track-ball, card reader, or other input devices. Additionally, the feature toggling system 114 may include output device 128 such as a liquid crystal display (LCD), video monitor, touch screen display, a light-emitting diode (LED), or other output devices. The output devices may be responsive to instructions to display textual information and/or graphical data.

In some examples, components of the feature toggling system 114, such as the biometrics library integrator 116, feature flag library integrator 118, application development tools 120, sentiment determiner 122, and feature flag toggler 124, may each be implemented as a computing system including a processor, a memory such as non-transitory computer readable medium coupled to the processor, and instructions such as software and/or firmware stored in the non-transitory computer-readable storage medium. The instructions may be executable by the processor to perform processes discussed herein. In some examples, these components of the feature toggling system 114 may include hardware features to perform processes described herein, such as a logical circuit, application specific integrated circuit, etc. In some examples, multiple components may be implemented using the same computing system features or hardware.

The client computing devices 104, 106, and 108 may host applications 112. The applications 112 may include any types of applications, such as desktop or laptop applications, mobile applications, web applications, cloud based applications, on-premise applications, etc. In examples where applications 112 include web applications, the client computing devices may host web browsers, which may be used to display, to end users of the client computing devices, web pages via execution of web applications on the web servers 110.

In some examples, the biometrics library integrator 116 may integrate a biometrics library 130 with the applications 112. The biometrics library 130 may comprise code, may be stored in the feature toggling system 114, and copies may be uploaded to the each of the client computing devices 104, 106, and 108 hosting instances of the applications 112. The upload may be automatic or in response to user input entered into the input device 126 by a user such as a developer or administrator using the feature toggling system 114. The biometrics library 130 may then be integrated with the applications 112, e.g. in response to input into the input device 126 by the user (e.g. developer or administrator). The biometrics library 130 may then be accessible by and interact with the applications 112, for example as a plugin to the applications 112.

For each application 112, the biometrics library 130 may act as a client side agent that may collect and log biometric data generated through usage of the application 112 by end users. Each unit of biometric data may be logged, including actions and states such as mouse clicks, mouse movements, screen touches, sequences of keyboard keys pressed, facial expressions (e.g. using a camera on the client computing device), geolocation (e.g. using Global Positioning System (GPS) device or using other localized data such as data associated with wireless networks accessed by the client computing device), client computing device movements (e.g. using accelerometers and gyroscopes), etc. The logging may be performed using various technologies, including HTML5 and various mobile software development kits (SDKs). Each unit of collected biometric data may be assigned (1) a unique end user ID corresponding to the end user using the application 112 at a given time, (2) a timestamp representing a time that the unit of collected biometric data was generated or when the biometric event represented by the biometric data occurred, (3) an application ID representing the particular application 112 being used by the end user at the time the biometric event occurred, and (4) a computing device ID representing the particular client computing device hosting the particular application 112 being used by the end user at the time the biometric event occurred. The biometrics library 130 may cause the collected biometric data associated with the end users of the application 112 to be continually sent automatically by the client computing device 104, 106, or 108 hosting the application 112 to the feature toggling system 114 to allow for on-demand calculations of user sentiment, and based thereon, feature toggling, as will be discussed.

In some examples, the feature flag library integrator 118 may integrate a feature flag library 132 with the applications 112. The feature flag library 132 may comprise code, may be stored in the feature toggling system 114, and copies may be uploaded to the each of the client computing devices 104, 106, and 108 hosting instances of the applications 112. The upload may be automatic or in response to user input entered into the input device 126 by a user such as a developer or administrator using the feature toggling system 114.

The feature flag library 132 may then be integrated with the applications 112, e.g. in response to input into the input device 126 by the user (e.g. developer or administrator). The feature flag library 132 may then be accessible by and interact with the applications 112, for example as a plugin to the applications 112.

For each application 112, the feature flag library 132 may act as a client side agent that may toggle feature flags in the applications 112 based on user sentiment data of each of the end users of applications 112. The user sentiment data may be inferred by the feature toggling system 114 based on the collected biometric data received from the biometrics library 114, and based on a command from the feature flag toggler 124 to the feature flag library 132, may send the user sentiment data to the feature flag library 132, which may then toggle the feature flags. The process above may be performed automatically or in response to inputs into the input device 126 by a user (e.g. developer or administrator) operating the feature toggling system 114.

In some examples, the application development tools 120 may include any software tools suitable for developing (e.g. coding) applications 112, including e.g. mobile, desktop, web, cloud, and on-premise applications, or other types of applications hosted to be hosted by the client computing devices. These tools may include applications allowing writing and compiling of code using various programming languages, as well as additional software tools and computing devices to aid application development by a developer or administrator operating the feature toggling system 114. In some examples, a user (e.g. developer) operating the feature toggling system 114 may, while or after developing code of the applications 112, may include feature flags (e.g. statements in the code) in the code. The user may then link these feature flags of the applications 112 with the feature flag library 132 such that the feature flag library 132 may access and toggle the feature flags.

In some examples, rather than including feature flags in the code of the applications 112, the feature flags of the applications 112 may be included in the feature flag library 132 rather than in the applications 112. For example, the feature flag library may include code that may be used to modify operation of applications 112 and therefore this code in the feature flag library may serve as a feature flag of the applications 112. Thus, a “feature flag of an application” is understood herein as referring to a feature flag that operates on the application, regardless of whether it is included in code of the application or in an external library.

In some examples, the sentiment determiner 122 may continually receive the biometric data associated with end users of the applications 112 as that biometric data is generated and collected using the copies of the biometrics library 130 at the client computing device 104, 106, and 108 hosting the application 112. The sentiment determiner 122 may select some of the units of biometric data, and based on the selected biometric data, the sentiment determiner 122 may infer a user sentiment for each end user of each of the applications 122 at each of the computing devices 104, 106 and 108, and generate user sentiment data representing the inferred user sentiment.

In some examples, for a given end user using a given application 112 on a given client computing device 104, 106, or 108, the inferred user sentiment of that end user may be based on units of selected biometric data assigned with (1) a unique end user ID corresponding to the given end user using the given application 112, (2) an application ID representing the given application 112 being used by the end user at the time the biometric event occurred, and (3) a computing device ID representing the given client computing device hosting the particular application 112 being used by the end user at the time the biometric event occurred. In some examples, these identified units of biometric data may be further filtered to those including timestamps covering a predetermined period of time, for example, timestamps no older than a threshold period of time (e.g. no older, relative to the current time, than the last 5 minutes), or timestamps covering a predetermined period of time with a start and end time (e.g. timestamps between 1:00 PM and 1:05 PM). In this way, the inferred user sentiment may reflect a user sentiment of the end user as a result of using a given application 112 (e.g. frustration, anger, happiness, etc.).

In some examples, user sentiment may be inferred using units of selected biometric data assigned with a unique end user ID corresponding to the given end user using the given application 112, and with any application ID and any client computing device ID, e.g. within a predetermined period of time. In this way, the inferred user sentiment may reflect a sentiment of the end user as a result of any interactions with any applications 112 and any client computing devices 104, 106, and 108 used within the predetermined period of time.

As mentioned earlier, the biometric data may include mouse clicks, mouse movements, screen touches, text inputs, sequences of keyboard keys pressed, facial expressions, geolocation, client computing device movements, etc. Table 1 shows an example lookup table storing predetermined mappings between units of biometric data and associated user sentiments. Each row of Table 1 shows the mapping for a particular unit of biometric data. Each unit of biometric data is associated with a biometric data type (e.g. the device used to detect the biometric event and the general type of user's usage of the device), biometric data details (e.g. involving more details on the user's usage of the device), the user sentiment associated with that unit of biometric data (e.g. positive or negative emotions, and what type of positive or negative emotions), and predetermined weights, which will be discussed

TABLE 1

| Biometric data type | Biometric data details | User Sentiment | Weight |
|---|---|---|---|
| Mouse movement | Very fast movement | Negative emotions: Anger | 0.6 |
| Mouse movement | Circular movement | Negative emotions: | 0.9 |
| | | Searching | |
| Sequence of | Repeated insert + delete | Negative emotions: | 0.3 |
| keyboard keys | action: More than 4 times | Frustration | |
| pressed | in a row | | |
| Client computing | Constant move or shake | Negative emotions: | 0.6 |
| device movement | without geolocation change | Anger/Enthusiastic | |
| Mouse movement | Jagged and sudden | Negative emotions | 0.7 |
| | movement | | |
| Mouse movement | Straight or smooth | Positive emotions | 0.6 |
| | movement | | |
| Mouse movement | Slow movement | Negative emotions: Upset | 0.2 |
| Facial expression | Happy facial expression | Positive emotions: Happy | 0.8 |
| | (Compared to simulated | | |
| | data) | | |
| Facial expression | Stressed facial expression | Negative emotions: | 0.8 |
| | (Compared to simulated | Stressed | |
| | data | | |
| Facial expression | Disgusted facial expression | Negative emotions: | 0.8 |
| | (Compared to simulated | Disgusted | |
| | data) | | |

In some examples, the inferred user sentiment may be based on a single selected unit of biometric data, in which case the inferred user sentiment may be the user sentiment (e.g. positive or negative emotions) associated with the selected single unit of biometric of the lookup table (e.g. as in Table 1).

In other examples, the inferred user sentiment may be based on multiple selected units of selected biometric data. For example, as discussed earlier, the sentiment determiner 122 may infer user sentiment based on a formula including the units of biometric data selected for an end user that have a timestamp within the predetermined period of time (e.g. involving a particular application and particular client computing device 104, 106, and 108, or involving any application and client computing device 104, 106, and 108). In these examples, the inferred user sentiment may be calculated using formulas.

In examples where positive but not negative units of biometric data are used, formula (1) may be used:

Positive user sentiment=Σᵢwᵢ⁺ (1)

In formula (1), the inferred user sentiment is a sum of weights wᵢ⁺ (taken from a lookup table such as Table 1) assigned to units of biometric data associated with positive user sentiments (taken from a lookup table such as Table 1). Thus, for example, referring to Table 1, if two units of biometric data associated with positive user sentiments are used, such as straight or smooth mouse movements (with a 0.6 weight) and a happy facial expression (with a 0.8 weight), then the inferred user sentiment may be a positive user sentiment ranging from a value of 0 to 1.4. Therefore, the inferred user sentiment may comprise a degree of positive user sentiment. For example, if an end user causes straight or smooth mouse movements but does not have a happy facial expression, the inferred degree of positive user sentiment may be 0.6. In some examples, the degree of particular units of biometric may be used to calculate the inferred degree of positive user sentiment. For example, if an end user causes straight or smooth mouse movements with half the degree of movements as defined in the lookup table, and has a happy facial expression with half of the intensity as defined in the lookup table, then a 0.3 weight may be assigned for the straight or smooth mouse movements, and a 0.4 weight may be assigned for the happy facial expression. This may result in a 0.7 total inferred degree of positive user sentiment.

In examples where negative but not positive units of biometric data are used, formula (2) may be used:

Negative user sentiment=Σⱼwⱼ⁻ (2)

In formula (2), the inferred user sentiment is a sum of weights wᵢ⁻ (taken from a lookup table such as Table 1) assigned to units of biometric data associated with negative user sentiments (taken from a lookup table such as Table 1). Thus, for example, referring to Table 1, if two units of biometric data associated with negative user sentiments are used, such as a constant move or shake of the client computing device without geolocation change (with a 0.6 weight) and a jagged and sudden mouse movement (with a 0.7 weight), then the inferred user sentiment may be a positive user sentiment ranging from a value of 0 to 1.3. Therefore, the inferred user sentiment may comprise a degree of negative user sentiment. For example, if an end user causes jagged and sudden mouse movements but does not cause a constant move or shake of the client computing device without geolocation change, the inferred degree of positive user sentiment may be 0.7. In some examples, the degree of particular units of biometric may be used to calculate the inferred degree of negative user sentiment. For example, if an end user causes as a constant move or shake of the client computing device without geolocation change with half the degree of movements as defined in the lookup table, and jagged and sudden mouse movements with half the degree of movements as defined in the lookup table, then a 0.3 weight may be assigned for the straight or smooth mouse movements, and a 0.35 weight may be assigned for the jagged and sudden mouse movements. This may result in a 0.65 total inferred degree of positive user sentiment.

In examples where both positive and negative units of biometric data are used, formula (3) may be used:

User sentiment=pΣᵢwᵢ⁺−nΣⱼwⱼ⁻ (3)

In formula (3), the inferred user sentiment is a weighted sum of the positive user sentiment and the negative user sentiment. Taking the examples described earlier, with the positive user sentiment may range from 0 to 1.4 and the negative user sentiment may range from 0 to 1.3. The weights p and n may be selected such that the ranges of the positive and negative user sentiments are equivalent, e.g. the range of positive sentiment extends from 0 to 1.0 and the range of negative sentiment extends from 0 to 1.0. In this example, the weight p may be equal to 10/14=0.71 and the weight n may be equal to 10/13=0.77 to normalize the ranges of positive and negative sentiment each to 0 to 1.0. Then, the user sentiment calculated by formula (3) may range from −1.0 to 1.0, where −1.0 represents a maximum degree of negative user sentiment, 1.0 represents a maximum degree of positive user sentiment, and 0 represents neutral user sentiment.

In some examples, a user (e.g. developer or administrator) operating the feature toggling system 114 may, e.g. while or after developing code of the applications 112, modify any parameters the lookup table (e.g. Table 1), including which units of biometric data to use, their associated user sentiments, and weight. This modification may be based on the user's accumulated experience with the relevance of various units of biometric data as indicators for user sentiment. In some examples, some units of biometric data may be ignored by setting their weights to zero. In some examples, the lookup table may include multiple weights, where the applied weight depends on features of a user, e.g. the user's location, nationality, or other features. In this way, weights may be selected based differences in ways of expressing user sentiment in different regions. Therefore, in some examples, the sentiment determiner 122 may, for a given unit of biometric data, determine automatically which weight to use depending on the client computing device's location or a stored end user profile. In some examples, any of the above modifications may be performed automatically, e.g. using big data analysis of end user actions over time to determine correlations between certain biometric data and user sentiments. For example, during testing processes, if a user sentiment is known through any technique (e.g. the end user inputs sentiment directly), the biometric data collected during that time may be associated with that user sentiment automatically, and weights for those collected biometric data may be increased automatically.

In some examples, the feature flag toggler 124 may send a command to the feature flag libraries 132 which may then toggle feature flags in the applications 112 based on the inferred user sentiment, as discussed earlier. In some examples, the particular feature flags to be triggered based on particular user sentiment data may be predefined in the feature flag library 132, e.g. in response to input into the input device 126 by the user (e.g. developer or administrator). Thus, once these mappings are predefined, the toggling may occur automatically in response to user sentiment being inferred.

In an example, the feature flag library 132 may include the feature flag object ActionObject of Table 2. ActionObject may runs a PosAction (positive action) object in response to an inferred positive user sentiment or a NegAction (negative action) object in response to an inferred negative user sentiment. The object may toggle a feature flag in the way responsive to the inferred user sentiment. In this example, the feature flag is in the feature flag library 132 rather than the application 112, and therefore the feature flag may need not be implemented as an ‘if-else’ statement in the code of the application 112.

TABLE 2

```
Public ActionObject getNextAction( ){
  User user = getCurrentLoggedUser( );
  if(SentimentFramework.isNeutralUser(user) == false){
    if(SentimentFramework.isExtremelyPositiveUser(user))
    {return new PosAction( );}
    if(SentimentFramework.isExtremelyNegativeUser(user))
    {return new NegAction( );}
  }
  return new DefaultAction( );
}
```

In some examples, a feature flag library 132 may interact with and toggle feature flags of an application 122 using dependency injections to control dependencies between the feature flag library 132 and the application 122. For example, the feature flag library 132 may inject a feature flag object such as ActionObject shown in Table 2 into an application 112. The dependency injection may be performed using the dependency injection code of feature flag library 132. An example dependency injection code is shown Table 3.

TABLE 3

@AutowiredBySentiment
Private ActionObject action;
Public triggerAction( ){
return action;
}

Various features may be implemented using feature flags. These may include new functionalities, bug fixes, messages to end users, etc. Some examples are given below.

In some examples, various messages may be displayed to end users, as follows. For example, feature flags may implement application surveys in response to an end user's experience being more threshold degree of positive user sentiment (e.g. in the −1.0 to 1.0 scale, greater than 0.5) or more than a threshold degree of negative user sentiment (e.g. in the −1.0 to 1.0 scale, less than −0.5). In another example, an advertisement may be selected for display in an application based on an end user's sentiment. In another example, the message ‘Your input is important to us. Our representative will call you in the next few minutes’ may be displayed in response to negative user sentiment, to enhance end user satisfaction.

In some examples, application testing and delivery may be performed, e.g. in the context of continuous delivery. For example, using feature flags and based on inferred user sentiment, new functionalities may be selectively deployed to users of an application 112, i.e. some users may receive a new functionality in the application 112 while others may not. This may allow testing of new functionalities. In a particular example of selective deployment, a new functionality (e.g. a beta feature) in development may be rolled out to end users (for e.g. beta testing) based on an end user's sentiment.

FIG. 5 is a flow diagram illustrating method 200 according to some examples. In some examples, the orderings shown may be varied, some elements may occur simultaneously, some elements may be added, and some elements may be omitted. In describing FIG. 5, reference will be made to elements described in FIG. 4. In examples, any of the elements described earlier relative to FIG. 4 may be implemented in the process shown in and described relative to FIG. 5.

At 202, a development phase may be performed, where the components of the system 100 are prepared for an operation phase at 210. The development phase may include 204, 206, and 208, and the operation phase may include 212 and 214.

At 204, the biometrics library integrator 116 may integrate a biometrics library 130 with the applications 112. Any relevant processes previously described as implemented by the biometrics library integrator 116 may be implemented at 204. The method 200 may proceed from 204 to 206.

At 206, the feature flag library integrator 118 may integrate a feature flag library 132 with the applications 112. Any relevant processes previously described as implemented by the biometrics library integrator 116 may be implemented at 206. The method 200 may proceed from 206 to 208.

At 208, the application development tools 120 may be used to develop applications using the biometrics library 130 and the feature flag library 132. Any relevant processes previously described as implemented by the application development tools 120 may be implemented at 208. The method 200 may proceed from 208 to 212.

At 212, the sentiment determiner 122 may, based on biometric data of end suers, infer a user sentiment for each end user of each of the applications 122 at each of the computing devices 104, 106 and 108. Any relevant processes previously described as implemented by the sentiment determiner 122 may be implemented at 212. The method 200 may proceed from 212 to 214.

At 214, the feature flag toggler 124 may send a command to the feature flag libraries 132 which may then toggle feature flags in the applications 112 based on the inferred user sentiment. Any relevant processes previously described as implemented by the feature flag toggler 124 may be implemented at 214.

Any of the processors discussed herein may comprise a microprocessor, a microcontroller, a programmable gate array, an application specific integrated circuit (ASIC), a computer processor, or the like. Any of the processors may, for example, include multiple cores on a chip, multiple cores across multiple chips, multiple cores across multiple devices, or combinations thereof. In some examples, any of the processors may include at least one integrated circuit (IC), other control logic, other electronic circuits, or combinations thereof. Any of the non-transitory computer-readable storage media described herein may include a single medium or multiple media. The non-transitory computer readable storage medium may comprise any electronic, magnetic, optical, or other physical storage device. For example, the non-transitory computer-readable storage medium may include, for example, random access memory (RAM), static memory, read only memory, an electrically erasable programmable read-only memory (EEPROM), a hard drive, an optical drive, a storage drive, a CD, a DVD, or the like.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject matter disclosed herein. However, examples may be practiced without some or all of these details. Other examples may include modifications and variations from the details discussed above. It is intended that the appended claims cover such modifications and variations.

1. A non-transitory computer-readable storage medium comprising instructions executable by a processor to:
infer a user sentiment of an end user that is interacting with an application to be executed on a client computing device based on biometric data of the end user; and
toggle a feature flag of the application based on the inferred user sentiment.

2. The non-transitory computer-readable storage medium of claim 1 wherein the biometric data comprises a mouse movement caused by the end user, a client computing device movement caused by the end user, facial expression of the end user, a mouse click caused by the end user, a screen touch by the end user, a geolocation of the end user, or a sequence of keyboard keys pressed.

3. The non-transitory computer-readable storage medium of claim 1 further comprising instructions executable by the processor to:
cause a biometrics library to be integrated with the application; and
collect the biometric data using the biometrics library.

4. The non-transitory computer-readable storage medium of claim 1 wherein the biometric data comprises a unique ID of the end user, a timestamp representing a time when a biometric event represented by the biometric data occurred, and an application ID of the application, wherein the infer the user sentiment comprises to infer the user sentiment based on the unique ID, the timestamp, and the application ID.

5. The non-transitory computer-readable storage medium of claim 1 further comprising instructions executable by the processor to cause a feature flag library to be integrated with the application, wherein to toggle the feature flag comprises to toggle the feature flag using the feature flag library.

6. The non-transitory computer-readable storage medium of claim 5 wherein the feature flag is in code of the application.

7. The non-transitory computer-readable storage medium of claim 5 wherein the feature flag is in code of the feature flag library.

8. The non-transitory computer-readable storage medium of claim 7 wherein to toggle the feature flag comprises to toggle the feature flag by performing a dependency injection of code from the feature flag library to the application.

9. The non-transitory computer-readable storage medium of claim 1 wherein the biometric data comprises a plurality of units of biometric data, and further comprising instructions executable by the processor to select units of biometric data of the plurality units of biometric data, and wherein to infer the user sentiment comprises to infer the user sentiment based on the selected units of biometric data.

10. The non-transitory computer-readable storage medium of claim 1 wherein the biometric data comprises a plurality of units of biometric data, each of the units of biometric data being associated with a positive user sentiment, wherein to infer the user sentiment comprises to infer the user sentiment based on a sum of weights each of which is associated with a respective unit of the units of biometric data.

11. The non-transitory computer-readable storage medium of claim 1 wherein the biometric data comprises a plurality of units of biometric data, each of the units of biometric data being associated with a negative user sentiment, wherein to infer the user sentiment comprises to infer the user sentiment based on a sum of weights each of which is associated with a respective unit of the units of biometric data.

12. The non-transitory computer-readable storage medium of claim 1 wherein the biometric data comprises a first unit of biometric data associated with a positive user sentiment and a second unit of biometric data associated with a negative user sentiment, wherein to infer the user sentiment comprises to infer the user sentiment based on a first weight associated with the first unit of biometric data and a second weight associated with a second unit of biometric data.

13. The non-transitory computer-readable storage medium of claim 12 wherein the biometric data comprises a third unit of biometric data associated with the positive user sentiment and a fourth unit of biometric data associated with the negative user sentiment, wherein to infer the user sentiment comprises to infer the user sentiment based on a difference between a first sum of the first and the third weights and a second sum of the second and fourth weights, wherein the third weight is associated with the third unit of biometric data and the fourth weight associated with the fourth unit of biometric data.

14. The non-transitory computer-readable storage medium of claim 13 wherein the first sum is normalized and the second sum is normalized.

15. The non-transitory computer-readable storage medium of claim 11 wherein, in response to the feature flag being toggled, the application is to display a message to the end user.

16. The non-transitory computer-readable storage medium of claim 11 wherein, in response to the feature flag being toggled, the application is to selectively deploy a functionality to the end user.

17. The non-transitory computer-readable storage medium of claim 17 wherein the selective deployment comprises rolling out the functionality to the end user during testing of the application, wherein the functionality comprises a beta feature.

18. A system comprising:
a processor; and
a memory comprising instructions executable by the processor to:
estimate whether a sentiment of an user that is interacting with an application to be executed on a client computing device based on units of biometric data of the end user is positive, negative, or neutral, wherein the biometric data is associated with the client computing device or a peripheral device in communication with the client computing device; and
based on the estimated sentiment, toggle a feature of the application using a feature flag of the application.

19. A method comprising:
by a processor:
collecting biometric data associated with an end user from a client computing device hosting an application being operated by the end user;
determining user sentiment data representing a user sentiment based on the biometric data; and
toggling a feature flag of the application based on the determined user sentiment data.

20. The method of claim 19 wherein the biometric data comprises a plurality of units of biometric data, and further comprising, by the processor, selecting units of biometric data of the plurality units of biometric data, and wherein determining the user sentiment data comprises to determine the user sentiment data based on the selected units of biometric data.
